(19) United States
(12) Patent Application Publication
(10) Pub. No.: US 2011/0073785 A1
(43) Pub. Date: Mar. 31, 2011

(54) Radiation Collector

(75) Inventors: Renaud Mercier-Ythier, Paris (FR); Roland Geyl, L'hay Les Roses (FR)

(73) Assignee: Sagem Defense Securite, Paris (FR)

(21) Appl. No.: 12/996,029

(22) PCT Filed: Jun. 4, 2009
(86) PCT No.: PCT/FR2009/051058

§ 371 Date: Dec. 3, 2010

(30) Foreign Application Priority Data
Jun. 5, 2008 (FR) 0853731

(51) Int. Cl. G21K 1/06

(52) U.S. Cl. 250/504 R

(57) ABSTRACT

The invention relates to a radiation collector (10) designed to concentrate part of the radiation produced by a source on a spot (100). The collector includes a primary concave mirror (1) and a secondary convex mirror (2), each being rotationally symmetrical about an optical axis (X-X) of the collector. The primary mirror is configured to reflect the radiation collected with an angle of incidence (i) that is substantially constant between different points on said main mirror. Such a collector is particularly suitable for use with a discharge produced plasma source.

The present invention relates to a radiation collector, and in particular such a collector that is adapted to collect radiation having a wavelength of about 13.5 nm (nanometre).

In order to obtain electronic circuits with a level of integration greater than is currently produced, it is envisaged to use lithographic techniques which are based on radiation of very short wavelength, called extreme ultraviolet (EUV). Typically, the EUV wavelength that is considered hereinafter is 13.5 nm.

Among the sources of such radiation that have been developed, those of the discharge produced plasma (DPP) type give a higher energy efficiency and smaller overall dimensions. However, their implementation encounters certain difficulties, among which there may be mentioned:
the EUV radiation is emitted by the source within a solid angle that is too wide to be used directly, so that it is necessary to concentrate a proportion of this radiation in a spot and in a solid angle that are suitable for the use of this radiation;
the EUV radiation is only produced in the direction of a front half-space that is located in front of the DPP source, and the back half-space is occupied by the components of the source itself;
a protective system, called a “mitigation device”, is required between the DPP source and a device utilizing the radiation, in order to protect the latter against debris of material expelled by the DPP source.

For these reasons, it is necessary to use a collector of the EUV radiation that is produced by a DPP source, and said collector must be arranged between the mitigation device and the device utilizing the EUV radiation. The following characteristics are then required for such a collector:
proportion of the radiation that is collected, relative to the total radiation that is produced by the source, which is a great as possible;
sufficiently uniform distribution of the radiation in the concentration spot produced by the collector;
dimensions of the radiation concentration spot, and an aperture angle of the beam that forms it, which are compatible with the device utilizing the EUV radiation;
placement of the collector between the source of radiation and the device utilizing the radiation;
aperture shape and dimensions for entry of the radiation into the collector that are compatible with the arrangement of the mitigation device between the DPP source and the collector;
overall dimensions of the collector itself that are compatible with installation of the collector on existing modules of a production line for integrated electronic circuits;
shapes of the mirrors of the collector that are compatible with existing processes for mirror fabrication, in particular the processes for machining the surfaces of mirrors and the processes for depositing reflective layers on said surfaces; and
a unit cost price of the collector that is reduced, in particular relative to the collectors with several concentric shells that are currently available, for example with eight shells.

An object of the present invention is therefore to propose a radiation collector that meets the above characteristics, in a manner that is improved relative to the existing collectors.

To this end, the invention proposes a radiation collector that is adapted to collect a portion of a radiation produced by a source, and to concentrate the collected portion of radiation in a spot formed by a convergent output beam produced by the collector. The collector comprises a primary mirror and a secondary mirror, each being rotationally symmetrical about an optical axis of the collector, and arranged to reflect the collected portion of the radiation firstly by the primary mirror and then by the secondary mirror.

The primary mirror is concave and has a first generatrix, in a meridian plane of the device containing the optical axis of the collector, which is in the range [0.8×R(α); 1.2×R(×)], where R and α are polar coordinates within the meridian plane, R being a radial coordinate measured from a point of the optical axis at which the source of radiation is intended to be placed and α being an angular coordinate measured from the optical axis, and R(α) being calculated according to the following equation (1):

R(α)=R₀·exp[−α·tan(i)] (1)

In this equation, a is expressed in radians, R₀ is a constant length, and i is a constant angle not equal to +/−90° (degrees).

The secondary mirror has a second generatrix in the meridian plane, which is adapted so that this secondary mirror produces the convergent output beam on a side of the collector opposite to the source of radiation, from the collected portion of the radiation that is reflected by the primary mirror.

The second generatrix of the secondary mirror within the meridian plane is constituted by points that are located in the domain [0.8×X(α); 1.2×X(α)]×[0.8×Y(α); 1.2×Y(α)], X and Y being Cartesian coordinates having as their origin the point of placement of the radiation source and X corresponding to the optical axis of the collector, X(α) and Y(α) being calculated according to the following equations (2) and (3):

$$\begin{matrix}X ( α ) = \frac{2 \cdot R ( α ) \cdot cos ( α ) \cdot [ \begin{matrix}L - R ( α ) \cdot \\ ( 1 + cos ( 2 i ) )\end{matrix} ] + ( \begin{matrix}{f}^{2} - {L}^{2} + \\ 2 \cdot L \cdot R ( α )\end{matrix} ) \cdot cos ( α )}{2 [ L - R ( α ) \cdot ( 1 + cos ( 2 i ) ) + f \cdot cos ( α ) ]} & ( 2 ) \\ Y ( α ) = R ( α ) \cdot sin ( α ) + [ X ( α ) - R ( α ) \cdot cos ( α ) ] \cdot tan ( α + 2 \cdot i ) & ( 3 )\end{matrix}$$

In these equations:

α is the angular polar coordinate of equation (1), which is used for parametrization of the Cartesian coordinates of the second generatrix,

R(α) is calculated according to equation (1),

f is the distance between the point of placement of the radiation source and the concentration spot of the collected portion of the radiation, measured along the optical axis, and

L is the length of an optical path between the point of placement of the radiation source and the concentration spot of the collected portion of the radiation, measured along a ray that is originating from the radiation source and reflected by the primary mirror and then by the secondary mirror.

Thus, a collector according to the invention only comprises two mirrors. It is therefore less complex and less expensive than known collectors that have more mirrors.

Moreover, all the radiation that is collected is reflected by the primary mirror and then by the secondary mirror, each of which is continuous. In this way, the radiation collected is not divided as a function of a plurality of separate mirrors acting in parallel and having identical roles. For this reason, the radiation collected is distributed more uniformly in the concentration spot that is produced by the collector.

The output beam containing the collected radiation is produced by the collector on a side that is opposite to that of the source. In other words, the radiation that is collected passes through the collector. In this way, the collector can easily be arranged between the source of radiation and a device utilizing this radiation, according to an alignment parallel to the optical axis of the collector.

For the same reason, a collector according to the invention is particularly suitable for a source of radiation whose back portion, on the side opposite to the radiation produced, is not unencumbered.

Moreover, for a collector according to the invention, the source of radiation is intended to be placed at a distance from the collector, in particular from the latter's primary mirror. Thus, a mitigation device can be interposed between the source of radiation and the collector.

For these reasons, a collector according to the invention is particularly suitable for being combined with a source of EUV radiation of the DPP type. For such a use of the collector in particular, the primary and secondary mirrors may be adapted to reflect EUV radiation, in particular radiation with a wavelength of 13.5 nm.

At the same time, a collector according to the invention can easily be arranged relative to a device utilizing the radiation, so that the concentration spot of the radiation collected is positioned at an optical entrance of the device utilizing the radiation.

In equation (1) of the generatrix of the primary mirror, i is a parameter of the collector that corresponds to the angle of incidence of the radiation from the source on said mirror, when the source is suitably positioned at the entrance of the collector. Throughout the following description, the angle of incidence of a ray that is reflected by any mirror is measured relative to a direction perpendicular to the surface of said mirror at the point of reflection of the ray. The angle of incidence of a ray originating from the source is therefore constant on the primary mirror, regardless of the reflection point on said mirror. The following advantages result from this property of the primary mirror:
the primary mirror can be optimized for this precise value of the angle of incidence, for example by being covered with a suitable set of layers;
the conditions of reflection of the radiation collected are identical at all points of the primary mirror, which contributes to obtaining a more uniform distribution of the radiation in the concentration spot produced; and
manufacturing of the primary mirror is thus facilitated. In particular, uniform deposits can be produced more easily on the primary mirror, by arranging a source of the deposited materials approximately at the point of placement of the radiation source relative to said primary mirror. Therefore it is not necessary to provide gradients for producing the deposits on the primary mirror, which endow it with its reflective behaviour. Treatment of the primary mirror with deposits of materials can then be very efficient.

These advantages become even greater as the generatrix of the primary mirror corresponds more accurately to equation (1). Thus, the strip of the meridian plane that contains the first generatrix may advantageously be narrower. In particular, this strip may be reduced to [0.95×R(α); 1.05×R(α)], or even preferably reduced to [0.98×R(α); 1.02×R(α)], or still better to [0.995×R(α); 1.005×R(α)],

Preferably, angle i may be between 20° and 60°, in particular in order to limit a total length of the collector parallel to its optical axis.

Generally, angle i may advantageously be fixed at a value not equal to the Brewster angle for the primary mirror and for the radiation that is produced by the source. For example, angle i may be outside of the range [35°; 45°]. Thus, a higher reflection coefficient can be obtained for the primary mirror. A greater quantity of radiation is then directed into the concentration spot. Nevertheless, for particular implementations of the radiation that is collected, the Brewster value may be selected for angle i.

The length R₀ may have any value. However, values between 70 cm (centimetre) and 2 m (metre) are particularly suitable with respect to the available DPP sources, as well as with respect to existing devices utilizing the radiation collected.

The secondary mirror may be adapted so that each point thereof on which a ray of the collected portion of the radiation is reflected receives this ray with an angle of incidence that is greater than 60°. In these conditions, the reflection coefficient of the secondary mirror can be high. In particular it can be above 50%.

The combination, according to the invention, of a primary mirror that is intended to operate with a single first value of the angle of incidence of the rays on this primary mirror, and that is optimized for this first value, with a secondary mirror that is intended to operate with high second values of the angle of incidence on this secondary mirror, results in a high overall efficiency of reflection of the collector.

Owing to the shape of the second generatrix of the secondary mirror, the portion that is collected of the radiation produced by the source is concentrated within a reduced spot at the exit of the collector.

In particular, this spot is even smaller when each point of the second generatrix is in the domain [0.95×X(α); 1.05×X(α)]×[0.95×Y(α); 1.05×Y(α)], within the meridian plane. Even more preferably, each point of the second generatrix may be in the domain [0.98×X(α); 1.02×X(α)]×[0.98×Y(α); 1.02×Y(α)] within the meridian plane, or still better in the domain [0.995×X(α); 1.005×X(α)]×[0.995×Y(α); 1.005×Y(α)] within this meridian plane.

Preferably, the distance f is comprised between 10 cm and 2 m, or even between 20 cm and 1.0 m, so that the collector and the DPP source can be installed easily on a module utilizing the radiation within a production line for integrated electronic circuits.

Also preferably, the length L is between 10 cm and 3 m.

In order to improve the invention, the secondary mirror has an aperture on a side that is opposite to the point of placement of the radiation source. In this case, the collector may further comprise at least one additional mirror that is rotationally symmetrical about the optical axis of the collector. Such additional mirror may be arranged to collect an additional portion of the radiation that is produced by the source by reflecting it. To this end, it optically conjugates the point of placement of the radiation source with a central point of the concentration spot of the portion of radiation that is collected by the primary and secondary mirrors. The additional portion of the radiation that is collected by the additional mirror then passes through the aperture of the secondary mirror, and is surrounded by the portion of the radiation that is collected by the primary and secondary mirrors, in planes perpendicular to the optical axis of the collector.

The additional mirror of the improvement may be a single ellipsoidal mirror.

Alternatively, the improvement may consist in adding two additional mirrors to the collector, further to the primary and secondary mirrors. These two additional mirrors may be a concave ellipsoidal mirror and a convex hyperboloidal mirror, which are arranged so that the additional portion of the radiation that is collected is reflected firstly by the ellipsoidal mirror and then by the hyperboloidal mirror. Moreover, the ellipsoidal mirror and the hyperboloidal mirror together form an optical doublet which optically conjugates the point of placement of the radiation source with the central point of the concentration spot of the radiation collected by the primary and secondary mirrors.

Other features and advantages of the present invention will become apparent from the following description of non-limitative example embodiments, with reference to the attached drawings in which:

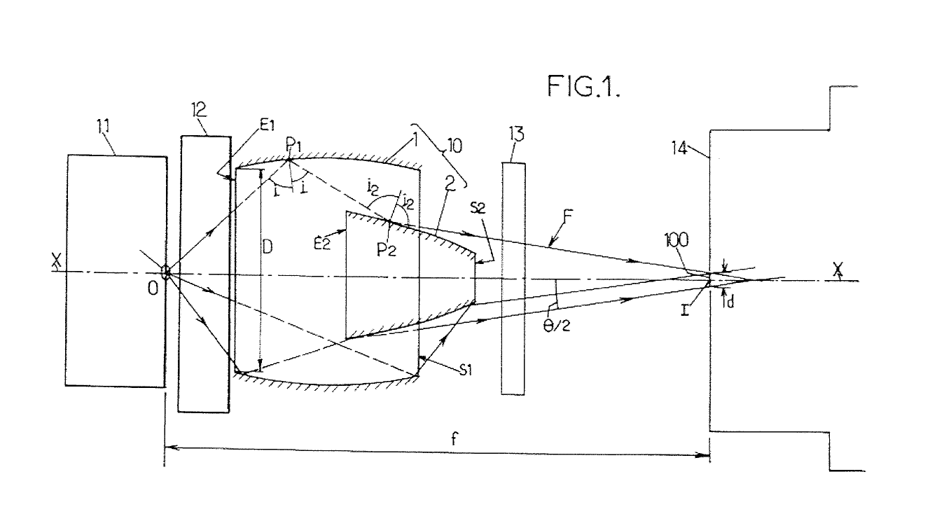

FIG. 1 illustrates an implementation of a collector according to the invention;

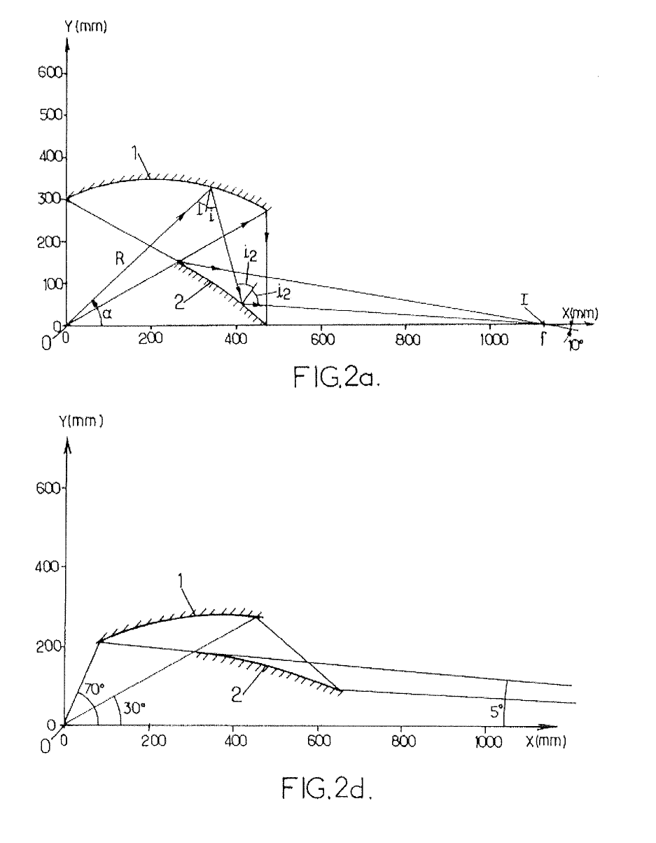

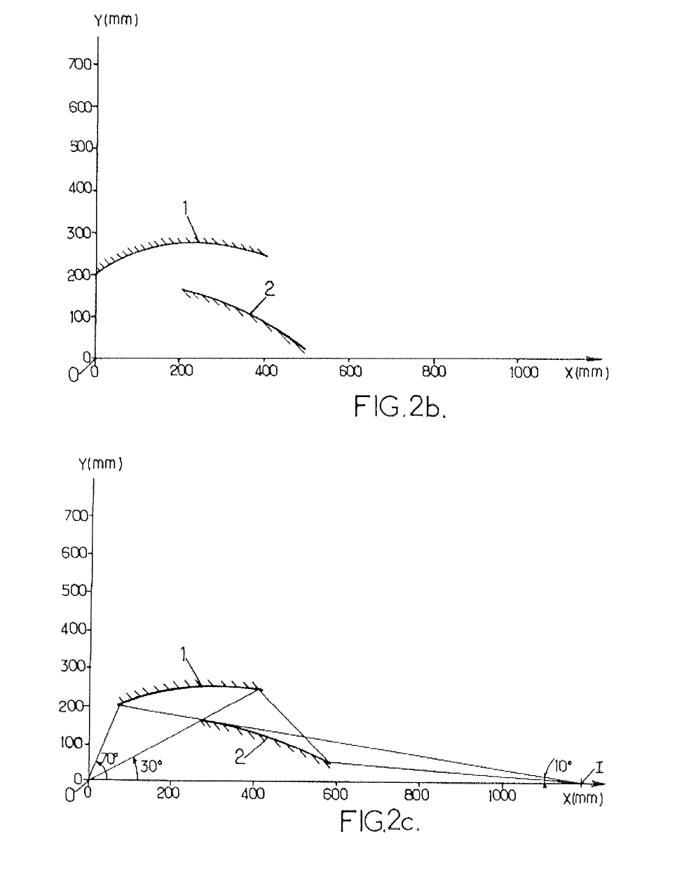

FIGS. 2a-2d are diagrams of generatrices of mirrors, respectively for four different collectors according to the invention; and

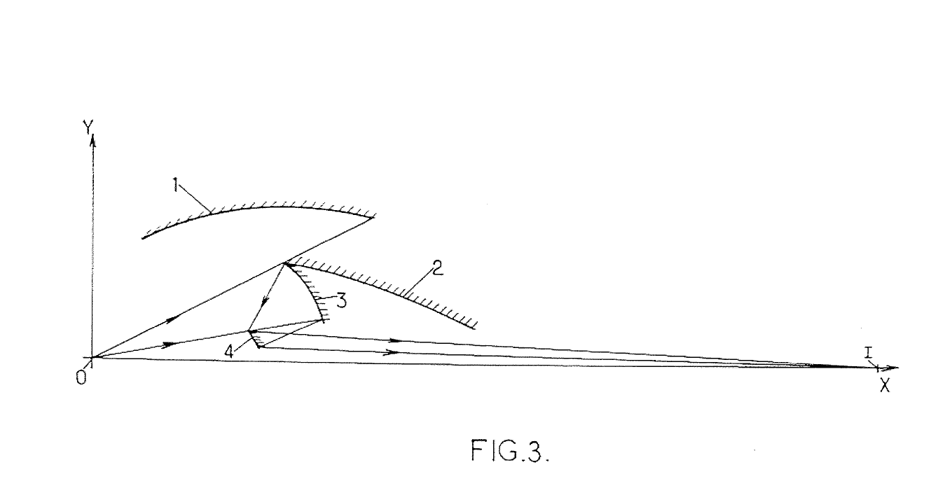

FIG. 3 illustrates an improved version of a collector according to the invention.

FIG. 1 is only for purposes of illustration, and for the sake of clarity of this diagram, the dimensions of the various elements shown do not correspond to actual dimensions or to ratios of actual dimensions.

In FIG. 1, a collector according to the invention has the general reference 10. It comprises a concave primary mirror 1 and a convex secondary mirror 2. Both mirrors 1 and 2 are each rotationally symmetrical about a common axis X-X, called the optical axis of the collector 10. In the implementation shown, the following devices are aligned along the axis X-X, in this order: a source of radiation 11, a mitigation device 12, the collector itself 10, radiation filter 13 and a device utilizing the radiation 14. The source 11 may be of the DPP type for producing radiation at 13.5 nm, and the other devices 10 and 12-14 are adapted so that each operates optically at this wavelength. In a manner that is known by a user of the DPP source, system 12 may be constituted by a blade wheel which is rotated rapidly about an axis parallel to axis X-X. Device 14 may be a lithographic processing module, for example. The radiation filter 13 is optional.

The source 11 produces the radiation from a volume of plasma 11a which is small, most often less than 1 mm³. It is arranged so that this volume of plasma is superposed on a focal point O of the collector 10. In these conditions, the radiation that is produced by the source 11 is concentrated by collector 10 in a convergent output beam, denoted F. This beam F forms a radiation concentration spot which has the reference 100, and which corresponds to the point along axis X-X at which beam F has a minimum cross-section. Device 14 has an optical entrance window, and it is arranged so that the spot 100 is positioned in this window.

When mirror 1 has a generatrix that complies with equation (1) in any meridian plane about axis X-X, a ray that originates from the focal point O is reflected on mirror 1 with an angle of incidence i that is constant, whatever the point P₁ of reflection on mirror 1. This remarkable property of mirror 1 that is introduced by the invention permits precise adjustment of a level of reflection of mirror 1 when it is used in these conditions. Indeed, in general, a reflection coefficient of a mirror is adjusted by means of a set of thin layers that are deposited on its surface. This set of layers is determined as a function of the wavelength of the radiation and as a function of the angle of incidence during reflection. The constant value of angle i along the surface of mirror 1 therefore makes it possible to determine and produce a stack of layers that produces the desired reflection coefficient on the whole surface of mirror 1. The design and manner of production of such a stack of layers is assumed to be known by a person skilled in the art, and is not repeated here. For example, the stack of layers may comprise at least forty layers, which are alternatively based on molybdenum or based on silicon. Optionally, mirror 1 may be produced in several parts, depending on its dimensions relative to the tools that are used for its manufacturing.

A ray originating from the volume of plasma 11a and that is reflected by mirror 1 is then reflected by mirror 2 towards spot 100. It is assumed that mirror 2 has a generatrix that complies with equation (2) in each meridian plane. The angle of incidence of the radiation on mirror 2 is not constant between points of this mirror that vary. In the figure, P₂ denotes the point of mirror 2 at which a ray coming from point P₁ on mirror 1 is reflected, and i₂ denotes the angle of incidence corresponding to point P₂. However, the angle of incidence i₂ is greater than the Brewster angle whatever the point of mirror 2, and is close to the grazing incidence for a large part of the mirror. In this way, the efficiency of reflection of mirror 2 is increased. Mirror 2 is suitably surface-processed to obtain such reflection. In particular, it may also comprise a stack of layers that is reflective for the radiation in question. Optionally, mirror 2 may be constituted by several successive slices along axis X-X, each in the shape of a crown. In this case, the stack of layers may be configured differently for each crown, in relation to a mean value of the angle of incidence i₂ of the radiation on this crown.

FIGS. 2a-2d are graphs constructed in any meridian plane of the collector 10, which correspond to the respective generatrices of mirrors 1 and 2. The abscissa in the meridian plane is the optical axis X-X of the collector, and the ordinate Y is perpendicular to the axis X-X. The two axes intersect at the focal point O of the collector, which is therefore the origin of the Cartesian coordinates X and Y. They are each marked in millimetres (mm). The radial distance R and the angle α, measured from the focal point O and the axis X-X, define polar coordinates in the meridian plane. The respective generatrices of mirrors 1 and 2 that are shown on these graphs correspond to equations (1) and (2), for the values of the parameters i, R₀, f and L that are given in the following Table 1:

TABLE 1

| | |
|---|---|
| Mirror 1 | Mirror 2 |

| Figures | i (degrees) | R₀ (mm) | f (mm) | L (mm) |
|---|---|---|---|---|
| 2a | 30 | 743 | 1110 | 1464 |
| 2b | 40 | 747 | 1134 | 1352 |
| 2c | 50 | 910 | 1204 | 1361 |
| 2d | 52.5 | 1084 | 2445 | 2600 |

L is the length of the optical path between the focal point O and point I at which the rays intersect the axis X-X after passing through collector 10. When mirrors 1 and 2 comply with equations (1) and (2), respectively, collector 10 is stigmatic between points O and I. In this case, the length L of the optical path between the focal point O and point I is constant, at least to first order, for different rays that are reflected by the two mirrors within the meridian plane. However, it is not necessary for the collector to be stigmatic. Then, from the collected radiation originating from the focal point O, a concentration spot of this radiation is produced, which has a non-zero minimum diameter at a given point on the axis X-X. FIG. 1 illustrates this astigmatic configuration of the collector 10. Reference 100 denotes the concentration spot of the radiation collected, and d denotes its diameter. The concentration spot of the portion of the radiation that is collected advantageously has a diameter less than 7 mm, preferably less than 5 mm, perpendicularly to the axis X-X. This size of the concentration spot is suitable for numerous devices utilizing the radiation 14.

The length of each mirror 1, 2, parallel to the axis X-X, may vary in relation to the following criteria, the list hereafter not being limitating:
the entry aperture E₁ of mirror 1, on the same side as the focal point O, may be located in a plane perpendicular to axis X-X, which is shifted towards the exit of the collector 10, in a manner that depends on the overall dimensions of the mitigation device 12 that is used;
the exit aperture S₁ of mirror 1, on the side opposite the focal point O, and the aperture E₂ of mirror 2 that is on the same side as the focus O, may be determined as a function of the mutual occultations that each of these apertures could cause on an edge of the other mirror; and
the aperture S₂ of mirror 2 on the same side as the exit of the collector may be fixed by tracing a ray that is reflected on the edge of mirror 1, also on the same side as the exit of the collector.

For example, aperture E₁ of mirror 1 is located in a plane that passes through the focal point O for the collectors in FIGS. 2a and 2b. For the collectors in FIGS. 2c and 2d, it corresponds to a value of 70° (degrees) of the polar angle α.

Preferably, the entry aperture E₁ of the primary mirror 1, on the same side as the point of placement of the radiation source, i.e. on the same side as the focal point O, has a diameter D that is greater than 200 mm (FIG. 1). This entrance cross-section of the radiation in collector 10 contributes to obtaining a high level of collection of the radiation produced by the source.

The aperture S₁ of mirror 1 on the same side as the exit of the collector, for the collectors in FIGS. 2c and 2d, corresponds to a value of 30° of the polar angle α.

The aperture S₂ of mirror 2 on the same side as the exit of the collector may be fixed in relation to the overall dimensions of filter 13, relative to the distance between mirror 2 and point I. Optionally, mirror 2 may be closed in the form of a point on the same side as the exit of the collector, when it is extended to the axis X-X (FIG. 2a).

Advantageously, the exit beam F of the collector, which is convergent and forms the concentration spot 100, may have a cone semi-angle θ/2 that is less than 15°, preferably less than 10°. By way of example, the semi-angle θ/2 is equal to 10° for the collectors in FIGS. 2a and 2c, and equal to 5° for the collector in FIG. 2d. Such values of the semi-angle θ/2 are suitable for numerous devices 14, and compatible with use of the filter 13 between collector 10 and device 14.

Using a collector according to the invention, with two mirrors as described up to now, the radiation that comes from the focal point O and is concentrated in spot 100 may correspond to a proportion that is greater than 20%, or even of the order of 25%, of the total radiation originating from the focal point O, in terms of intensity. In other words, the collection proportion of the radiation is above 20%, or even above 25%.

An improvement of the invention that makes it possible to increase the proportion of radiation collected by about 5% will now be described. According to FIG. 3, two additional mirrors 3 and 4 may be added, in addition to mirrors 1 and 2. The two additional mirrors 3 and 4 are each rotationally symmetrical about the optical axis X-X of the collector.

Mirror 3 is concave ellipsoidal and mirror 4 is convex hyperboloidal. They are arranged so as to collect an additional portion of the radiation that is produced by the source at the focal point O, by reflecting this additional portion of radiation firstly on mirror 3 and then on mirror 4. Moreover, they form a doublet which optically conjugates the focal point O and the centre I of the concentration spot 100 of the portion of the radiation that is collected by mirrors 1 and 2. FIG. 3 is only given as an illustration of the principle of this improvement, and a person skilled in the art will be able, from this principle, to determine the geometric characteristics of mirrors 3 and 4.

In order to implement this improvement, the secondary mirror 2 must be open on the same side as the exit of the collector, opposite the focal point O. The additional portion of the radiation that is collected by mirrors 3 and 4 then passes through this aperture, and is surrounded by the portion of the radiation that is collected by mirrors 1 and 2, in planes perpendicular to the axis X-X.

In all the embodiments of a collector according to the invention that have just been described, mirror 1 may in further have a function of suppression of a portion of the radiation that is produced by the source, and that would not be desired in the concentration spot 100. To this end, mirror 1 may be absorbing for radiation that has a wavelength greater than that of the collected portion of the radiation that is concentrated in spot 100. In this case, the collector may additionally comprise a cooling system that is arranged for cooling mirror 1, in order to remove the energy of the radiation that is absorbed by this mirror.

1. Radiation collector, adapted to collect a portion of a radiation produced by a source and to concentrate said collected portion of the radiation in a spot formed by a convergent output beam produced by said collector,
said collector comprising a primary mirror and a secondary mirror, each being rotationally symmetrical about an optical axis of the collector, and arranged to reflect the collected portion of the radiation firstly by said primary mirror and then by said secondary mirror,
the primary mirror being concave and having a first generatrix in a meridian plane of the device containing the optical axis of the collector, located in the domain [0.8×R(α); 1.2×R(α)], R and α being polar coordinates within the meridian plane, R being a radial coordinate measured from a point of the optical axis at which the source of radiation is intended to be placed and a being an angular coordinate measured from said optical axis, and R(α) being calculated according to the following equation (1):
R(α)=R₀·exp[−α·tan(i)] (1)
where α is expressed in radians, R₀ is a constant length, and i is a constant angle not equal to +/−90°, and
the secondary mirror having a second generatrix in said meridian plane, adapted so that said secondary mirror produces the convergent output beam on a side of the collector opposite to the source of radiation, from the collected portion of the radiation reflected by the primary mirror, the second generatrix of the secondary mirror being constituted by points having Cartesian coordinates X and Y within the meridian plane, the origin of said Cartesian coordinates being the point of placement of the radiation source and X corresponding to the optical axis of the collector,
each point of the second generatrix being located in the domain [0.8×X(α); 1.2×X(α)]×[0.8×Y(α); 1.2×Y(α)], X(α) and Y(α) being calculated according to the following equations (2) and (3):
$$\begin{matrix}X ( α ) = \frac{2 \cdot R ( α ) \cdot cos ( α ) \cdot [ \begin{matrix}L - R ( α ) \cdot \\ ( 1 + cos ( 2 i ) )\end{matrix} ] + ( \begin{matrix}{f}^{2} - {L}^{2} + \\ 2 \cdot L \cdot R ( α )\end{matrix} ) \cdot cos ( α )}{2 [ L - R ( α ) \cdot ( 1 + cos ( 2 i ) ) + f \cdot cos ( α ) ]} & ( 2 ) \\ Y ( α ) = R ( α ) \cdot sin ( α ) + [ X ( α ) - R ( α ) \cdot cos ( α ) ] \cdot tan ( α + 2 \cdot i ) & ( 3 )\end{matrix}$$
where α is the angular polar coordinate of equation (1) used for parametrization of the Cartesian coordinates of the second generatrix, R(α) is calculated according to equation (1),
f is the distance between the point of placement of the radiation source and the concentration spot of the collected portion of the radiation, measured along the optical axis, and
L is the length of an optical path between the point of placement of the radiation source and the concentration spot of the collected portion of the radiation, measured along a ray originating from said point of placement of the radiation source and reflected by the primary mirror and then by the secondary mirror.

2. Collector according to claim 1, in which angle i is between 20° and 60°.

3. Collector according to claim 1, in which angle i is outside of the range [35°; 45°].

4. Collector according to claim 1, in which the first generatrix of the primary mirror is moreover located in the domain [0.95×R(α); 1.05×R(α)], within the meridian plane.

5. Collector according to claim 1, in which the primary mirror has an entry aperture on the same side as the point of placement of the radiation source, with a diameter greater than 200 mm for said aperture.

6. Collector according to claim 1, in which the secondary mirror is adapted so that each point of said secondary mirror reflecting a ray of the collected portion of the radiation receives said ray with an angle of incidence greater than 60°.

7. Collector according to claim 1 , in which each point of the second generatrix is in the domain [0.95×X(α); 1.05×X(α)]×[0.95×Y(α); 1.05×Y(α)], within the meridian plane.

8. Collector according to claim 1, adapted moreover so that the concentration spot of the collected portion of the radiation has a diameter less than 7 mm, perpendicularly to the optical axis.

9. Collector according to claim 1, adapted moreover so that the convergent output beam, which forms the concentration spot of the collected portion of the radiation, has a cone semi-angle less than 15°.

10. Collector according to claim 1 , in which the primary and secondary mirrors are adapted to reflect extreme ultraviolet radiation produced by the source.

11. Collector according to claim 10, in which the primary and secondary mirrors are adapted to reflect radiation produced by the source having a wavelength equal to 13.5 nm.

12. Collector according to claim 1 any one of the preceding claims, in which the primary mirror is absorbing for another portion of the radiation produced by the source, with a wavelength greater than a wavelength of the collected portion of the radiation that is concentrated on the spot formed by the convergent output beam, and
said collector comprising moreover a cooling system arranged for cooling the primary mirror.

13. Collector according to claim 1, in which the secondary mirror has an aperture on a side opposite to the point of placement of the radiation source, and
said collector comprising moreover at least one additional mirror, rotationally symmetrical about the optical axis of the collector, arranged for collecting an additional portion of the radiation produced by the source by reflecting said additional portion of radiation, and for optically conjugating the point of placement of the radiation source with a central point of the concentration spot of the portion of the radiation collected by the primary and secondary mirrors,
said additional mirror being arranged moreover so that said additional portion of the radiation that is collected passes through the aperture of said secondary mirror, and is surrounded by the portion of the radiation that is collected by the primary and secondary mirrors, in planes perpendicular to the optical axis of the collector.

14. Collector according to claim 13, in which said at least one additional mirror comprises a concave ellipsoidal mirror and a convex hyperboloidal mirror, each being rotationally symmetrical about the optical axis of the collector, arranged for collecting the additional portion of the radiation produced by the source by reflecting said additional portion of radiation firstly on the ellipsoidal mirror and then on the hyperboloidal mirror.
